(19) United States
(12) Patent Application Publication
(10) Pub. No.: US 2010/0093445 A1
(43) Pub. Date: Apr. 15, 2010

(54) Thermal management in a gaming machine

(75) Inventors: Harold E. Mattice, Gardnerville, NV (US); James W. Stockdale, Clio, CA (US); Richard L. Wilder, Sparks, NV (US); Michael P. Khamis, Reno, NV (US); Chauncey W. Griswold, Reno, NV (US)

Correspondence Address: Weaver Austin Villeneuve & Sampson LLP - IGT;Attn: IGT, P.O. Box 70250, Oakland, CA, 94612-0250, US

(73) Assignee: IGT

(21) Appl. No.: 12/287,944

(22) Filed: Oct. 14, 2008

(51) Int. Cl. A63F 9/24; G01K 15/00

(52) U.S. Cl. 463/46; 702/99

(57) ABSTRACT

A gaming machine has thermal control components for controlling its internal temperature. Temperatures within the cabinet of the machine may be controlled by either monitoring the temperatures near or of heat-producing components, such as the CPU, video controllers, and the like, or by monitoring ambient temperatures in zones or areas within the machine. These thermal control components include a thermal management sub-system, fans, baffles, digital thermometers, and control signal alarms. Also included is a thermal specification profile or table that includes thermal data for heat-producing components in the machine. Such data may include high temperature thresholds, such as an alert and alarm temperatures, instructions or actions to be taken when those temperatures are met, and which elements within the machine to use, such as baffles, fans, and the like. In this manner, the internal temperatures of a gaming machine may be more finely controlled and elements within the machine for cooling are used only when needed.

### BACKGROUND OF THE INVENTION

1. Field of the Invention

The present invention relates to wager gaming machines. More specifically, it relates to thermal management within a gaming machine.

2. Description of the Related Art

With energy prices rising, gaming operators and casinos are looking for ways to reduce power consumption in their gaming machine operations. Generally, this is in line with the trend over the past few years to develop a more environmentally efficient gaming machine (a so-called “green” machine), where sub-systems within the gaming machine are optimized to run more intelligently and efficiently, thereby reducing energy consumption while maintaining normal standards of game play and non-gaming functionality. That is, although gaming operators would like a green gaming machine so that they use less power, they do not want gaming machines that are less appealing to the game player and are not as likely to encourage game play.

One sub-system which may be managed more efficiently to reduce power consumption, increase the life of gaming machine, and require less maintenance by the gaming operator is the thermal management system. Presently, input fans and exhaust fans are used to cool components and areas within the gaming machine. However, the fans typically operate at their maximum RPMs (i.e., at full power). Presently, there are no mechanisms for adjusting the power of the fans or fine tuning them to operate, for example, at low, medium, or high speeds, or simply be turned off when they are not needed. Presently, when a gaming machine is powered on, all the fans go on as well.

Having all the fans in a gaming machine operating nearly continually while the machine is on creates several issues. One is the increase in white noise level of the casino from the din of the fans' constant operation. There is significant background noise created from fans having slightly different sound frequencies. The oscillation of the frequencies create a worble-type sound resulting from fans operating in multiple machines arranged close to one another (e.g., in row after row of hundreds of gaming machines). This audible beat frequency may be a distraction or annoyance to gaming machine users, thus potentially reducing the time they spend playing the machines.

Another issue is maintenance and wear-and-tear from fans operating constantly. As is commonly known, fans become old and do not operate as efficiently as they did when they were new. Many old fans need extra power to “kick start” or they may break down or overheat. Presently there are no alarms or other problem indicators in a gaming machine or in a gaming network that inform casino floor technicians or gaming network administrators of fan maintenance issues or breakdowns.

### SUMMARY OF THE DESCRIBED EMBODIMENTS

A gaming machine includes specific components for controlling its internal temperature. Temperatures within the cabinet of the machine may be controlled by either monitoring temperatures near heat-producing components or their actual temperatures or by monitoring ambient temperatures in zones or areas within the machine. These components include a thermal management sub-system, fans, baffles, digital thermometers, and control signal alarms. The gaming machine memory includes a thermal specification profile or table that includes data on threshold temperatures and actions to be taken when those thresholds are passed.

One embodiment of the present invention is a gaming machine having one or more heat-emanating components. In addition to including a master gaming controller (CPU), it also includes baffles, fans, and a thermal management component for regulating temperatures in the gaming machine. Also included is a temperature monitoring device having a temperature-detection span. A memory stores one or more thermal specification profiles corresponding to the one or more heat-emanating components, wherein a thermal specification profile contains temperature range data and other data such as actions to be taken when certain conditions are met and which cooling elements are to be used in the specified actions.

In another embodiment, a method of regulating temperatures in a gaming machine is described. Components and thermal measuring devices obtain temperatures and transmit them to a thermal management component. The temperature readings are compared with stored temperature thresholds, the temperature data stored in a thermal specification profile, for example, a relational table having fields for temperatures, actions, cooling elements, and other data. It may then be determined if there is an out-of-range temperature condition based on the comparison. If there is such a condition, it is determined whether the condition can be addressed using a temperature-related control signal sent from the thermal management component to various cooling elements within the machine. If the condition can be addressed (e.g., starting a fan, opening a baffle), a control signal is sent to the cooling element. If the temperatures reach a certain value, an alarm condition may be set requiring immediate action by the gaming machine (e.g., going to a tilt state) and notifying the gaming operator.

In another embodiment, a gaming machine comprises a means for obtaining a temperature reading of a component, such a digital thermometer in the vicinity of the component. In other embodiments, the component may be self-thermal measuring and is able to essentially take its own temperature. The temperature readings are compared to data in a thermal data table, stored in the gaming machine's memory. The comparison may be done by a thermal management sub-system or component or a temperature condition comparison module. These components may also be used to determine whether a temperature reading is above one of the threshold temperatures for the specific device as provided in the thermal data table. The gaming machine includes means for determining if the out-of-range temperature condition can be addressed using a temperature-related control signal and means for transmitting the control signal to a fan or a baffle to regulate the temperature.

### BRIEF DESCRIPTION OF THE DRAWINGS

References are made to the accompanying drawings, which form a part of the description and in which are shown, by way of illustration, particular embodiments:

FIG. 1 is a block diagram of a gaming machine showing components, modules, sub-systems, and areas (or zones) relevant to thermal management of the machine in accordance with one embodiment;

FIG. 2 is a logical block diagram of various input sources to a TMSS in accordance with one embodiment;

FIG. 3 is a logical block diagram showing various outputs from TMSS 132 to components and devices in a gaming machine in accordance with one embodiment;

FIG. 4 is a flow diagram of a process of regulating temperature in a gaming machine in accordance with one embodiment; and

FIG. 5 is an example of a thermal data table for use in a gaming machine in accordance with one embodiment.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In addition, well known process operations have not been described in detail in order to not unnecessarily obscure the present invention.

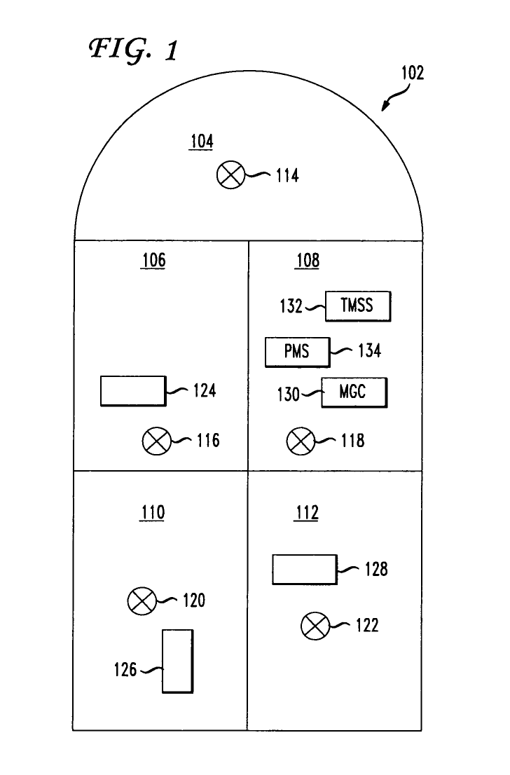

Methods and systems for regulating temperatures within a gaming machine are described in the various figures. In one embodiment, thermal management is generally achieved through the use of fans strategically configured within the top box and cabinet of the gaming machine. Such fans may be input fans, which draw typically cooler air into the gaming machine or outlet (exhaust) a fan which draws warmer air out of the machine. FIG. 1 is a block diagram of a gaming machine showing components, modules, sub-systems, and areas (or zones) relevant to thermal management of the machine in accordance with one embodiment. A gaming machine 102 may have one or more thermal zones, such as the five zones 104 (top box) and zones 106 to 112 in the main cabinet. In other embodiments there may only be one thermal zone (the entire interior of the gaming machine cabinet) or more or fewer than five zones, depending on the physical features and location of the gamine machine. Also shown are five sample fans 114 to 122. The number and arrangement of fans in a gaming machine may vary widely depending on the type of gaming machine and manufacturer. Multi-station gaming machines, such as gaming tables, may have more or fewer fans than a single-player gaming machine.

In one configuration, the top box of a gaming machine may have one fan, for example, an outlet fan for blowing air out of the machine. There may be another fan near the power supply. The master gaming controller may have one fan nearby or solely dedicated to it. In general, each critical gaming machine component that receives enough current to get hot and contribute to a temperature rise in the gaming machine may have a fan in its vicinity. Sample components are shown by generic boxes 124, 126, and 128, one of which, for example, may be the gaming machine power supply. A master gaming controller (MGC) 130 is shown close to fan 118. Fans may be configured within the gaming machine cabinet based on thermal zones 104 to 112 and based on location of critical or heat-producing components 124 to 130. In a zone embodiment, it is not necessary that there be one fan in each zone; the number of fans may vary. Nor is it necessary that each critical component have a dedicated fan. Fans may be configured in a gaming machine by taking into account both thermal zones and the number of critical components and their placement within the machine. Generally, in a zone embodiment, fans operate to cool their specific zones.

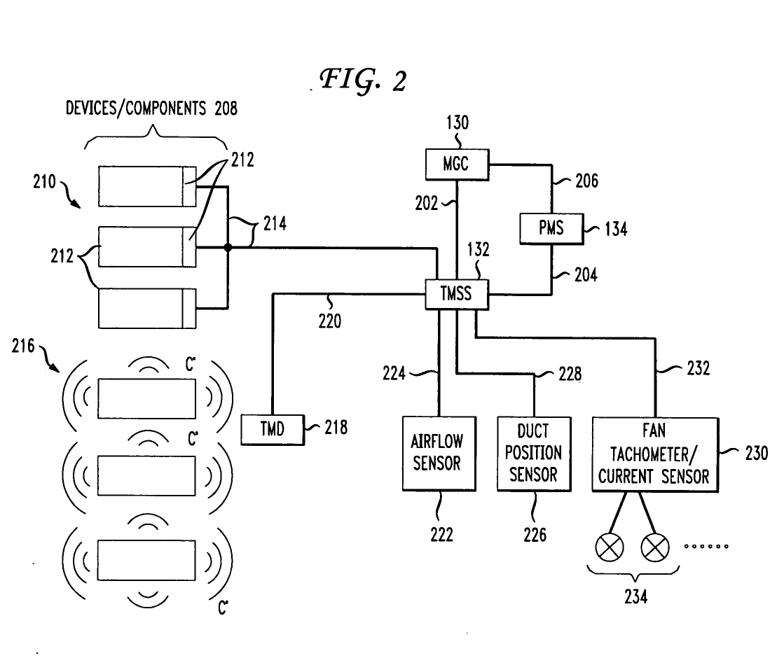

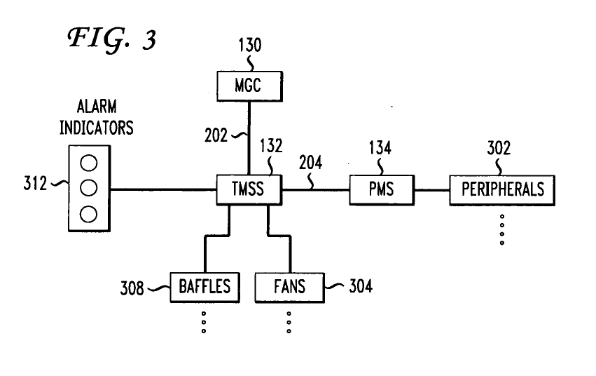

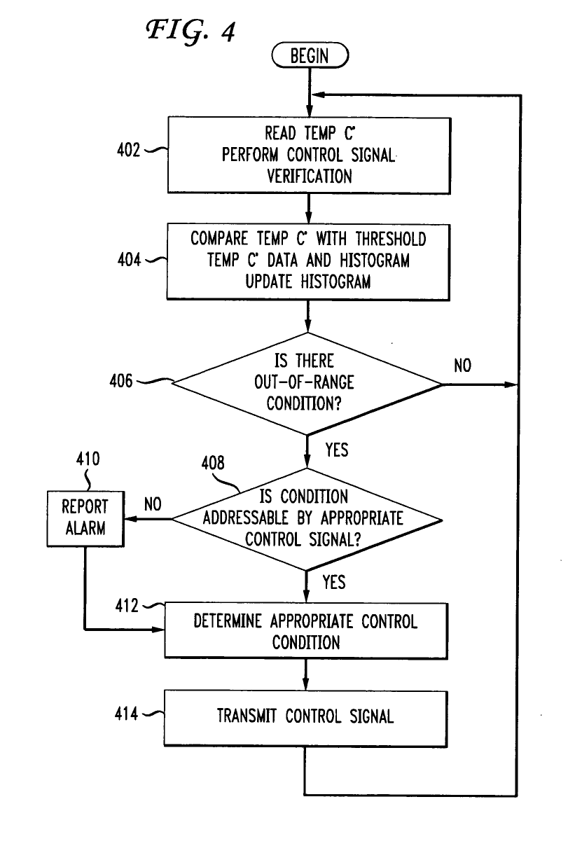

Also shown in FIG. 1 is a thermal management sub-system (TMSS) 132 and a power management system (PMS) 134. TMSS 132 may be a software module or a hardware component, such as microcontroller with I/O ports, embodied with firmware for managing the temperature of the gaming machine. This may be done by taking into account temperatures of various components and/or zones and adjusting various temperature-controlling devices and mechanisms. In one embodiment there is one TMSS for the entire gaming machine. In another embodiment, there may be one TMSS 132 for each thermal zone, if a zone implementation is used. Examples of inputs and outputs to TMSS 132 are described in FIGS. 2 and 3. The logic performed by TMSS 132 in accordance with one embodiment is described in FIG. 4. The role of PMS 134 in thermal management of the gaming machine is also described in the figures below. For example, PMS 134 may transition components, peripherals, and the like into (or out of) sleep mode, low power mode, or stand-by mode, and other states that draw less power. It may also reduce brightness of displays, signage lighting, and so on, all of which may affect the temperature in a machine.

FIG. 2 is a logical block diagram of various input sources to a TMSS in accordance with one embodiment. In one embodiment, TMSS 132 is connected via communication bus 202 with MGC 130, which may be an Ethernet connection, serial connection, or other suitable connection means. In another embodiment TMSS 132 may be connected to PMS 134 via communication line 204. PMS 134 is connected to MGC 130 via communication line 206. These embodiments show two communication means between TMSS 132 and MGC 130. The nature of the communication between two components is described below. PMS 134 may be connected to various peripheral devices which may consume high amounts of current and create heat within the gaming machine. Controlling the operation of these peripherals, including lighting, is one way TMSS 132 may regulate the temperature of the machine.

Multiple devices and components 208 operate within the gaming machine. These may include peripheral devices that interface with the player, such as RDC readers, bill validators, ticket printers, card readers, coin hoppers, and so on. In one embodiment, they are attached to PMS 134 (connections not shown in FIG. 2), which regulates power to the devices. Components may include a chip, sub-system, power supply, lights, amplifiers, disk drives, or other critical hardware or physical component in the gaming machine that emanate heat. As noted, MGC 130 is an example of a critical component, one that of may produce a level of heat that may require one or more dedicated fans. Most of the devices/components 208 have thermal specifications that are available to the gaming machine manufacturer. Such specifications typically comprise temperature ranges and corresponding levels (e.g., high, low, alarm, below low (cool), etc.). The use of thermal specifications is described below.

Devices/components 208 (“devices”) may be characterized into two categories. One category or type is comprised of devices that are capable of self-thermal monitoring; that is, they have the ability to determine their own temperature and report it to another component. They often have some type of electrical interface (SPI, serial, etc.) that enables transmission of their internal temperature. This ‘built-in’ intelligence of such devices is known in the field of device manufacturing and thermal management. In FIG. 2 these devices are shown as devices 210 and their electrical interfaces for transmitting temperature data are represented by areas 212. Temperature data from device 210 is communicated to TMSS 132 over communication links 214.

Another category of devices 208 is comprised of devices that do not have the built-in capability to monitor their internal temperatures. For example, some of the mechanical devices, such as coin hoppers or card readers, may not be capable of reporting their temperatures. These non-self monitoring devices 216 may not have direct communication links to TMSS 132. Instead, in one embodiment, their temperatures are communicated to TMSS 132 via a temperature monitoring device 218. Devices 216 may emanate heat when operational (or some may give off heat even when simply powered on) and temperature monitoring device (TMD) 218 is a suitable thermometer that measures the temperature of the air around devices 216. In one embodiment, TMD 218 is an electronic thermometer, such as a thermo-coupled thermometer, known in the art, which generates a voltage reading based on the ambient temperature within a specific span or area around the thermometer. Such thermometers are commercially available from Omega Engineering Inc, of Stamford, Conn. Other types of thermometers or TMDs may report temperatures in terms of changes in resistance or changes in oscillation frequency. TMD 218 may be in proximity of one or more devices 216 (within the temperature detecting span of the thermometer) or may even be in physical contact with such devices. TMD 218 may use various means for determining the temperature, such as air pressure difference, air flow, “thermal tubes,” and the like. Most TMDs simply provide a temperature value, which may be in analog or digital form. TMD 218 has a communication link 220 to TMSS 132, which may have logic or hardware to convert the temperature data received from TMD 218 (e.g., in the form of volts or pressure differential) into a form that is useful to TMSS 132 and that it can manipulate.

In one embodiment, TMSS 132 may also be connected to an airflow sensor 222, also referred to as a sail switch, via communication link 224. Airflow sensor 222 is used to measure or sense airflow in a zone or area of the gaming machine. In one embodiment, sensor 222 is a mechanical device that consists of a flap or sail that pivots if there is airflow. Various types of airflow sensors are known in the field of thermal management. A duct position sensor 226 is also connected to TMSS 132 via communication link 228. Sensor 226 may sense or detect a baffle position, which may be important when a fan fails or stalls. Baffle positions may change to facilitate removal of hot air in areas where a fan has failed. In this manner, a certain redundancy is incorporated into the thermal management system. That is, even if a fan fails and an area or zone gets hot as a result, duct position sensor 226 may prevent the area from rising above a threshold temperature by enabling a change in baffle position or opening or closing a baffle.

Also connected to TMSS 132 is a fan tachometer 230 connected via communication link 232. Tachometer 230 is also connected to one or more fans 234 in the gaming machine. In one embodiment, tachometer 230 calculates or measures fan speed by analyzing current (power) consumption of a fan. In this respect, tachometer 230 may also be referred to as a fan current sensor. Tachometer 230 may also measure pulses from the fan or fan RPMs with the goal of determining whether the fans are operating effectively. In another embodiment, this may be done by using two electronic thermometers associated with each fan, where one thermometer is placed on each side of the fan and the difference in temperatures between the two indicating whether the fan is functioning.

FIG. 3 is a logical block diagram showing various outputs from TMSS 132 to components and devices in a gaming machine in accordance with one embodiment. As shown in FIG. 2, TMSS 132 has a communication link 202 with MGC 130. TMSS 132 may send a message to MGC 130 to stop game play or go into a tilt state if the machine is overheated and should shutdown. Preferably, this would be done at the end of a game if one is in progress. It may also have a communication link 204 with PMS 134, which is connected to various peripheral devices 302, as described above. TMSS 132 may transmit a message to PMS 134 indicating that all is fine and that none of the machine's peripheral devices need to be powered down (or placed in an idle or wait state). It may also transmit a message indicating that a particular peripheral device is overheating or causing a zone or area in the gaming machine to rise above a threshold temperature, in which case PMS 134 will take appropriate action.

TMSS 132 may also be connected to one or more fans 304, the number of which may depend on whether there is one TMSS 132 for the entire gaming machine or whether there is one for each zone or section of the machine (e.g., top box, cabinet, etc.). TMSS 134 may transmit fan control signals to fans 304 via control signal line or communication line 306. These control signals instruct one or more fans to adjust their speed or power, or to shut off because they are not needed. As noted above, fans presently remain on constantly while the gaming machine is powered and usually at full speed, which reduces the life of the fan and wastes energy. By sending fan control signals, TMSS 132 is able to control the speed of fans 304 with a granularity that will increase the life of the fan and save power. Also connected to TMSS 132 are baffles 308 which may be used to re-direct air circulation within a gaming machine. Various types of baffles and mechanisms for controlling them may be used. Some suitable ones may use solenoids, stepper motors, and other means. Such mechanisms may allow a baffle to be open (or closed) by a certain fraction, (e.g., ½ or ¼). TMSS 132 may transmit baffle control signals via communication link 310.

Another output of TMSS 132 are discrete alarm indicators 312 which may be implemented using any suitable visual or audio means to notify casino floor technicians or gaming network administrators. An alarm may be transmitted from TMSS 132 in a variety of situations, such as when a specific fan in the machine is not operating or a baffle or sail switch is stuck in one position. The alarm may be in the form of a visual indicator, such as an LED light or a number on the display. Alarm indicators 312 may specifically identify a problem by displaying details on a monitor in the machine that can be viewed by a technician. For example, data on which fan is malfunctioning and the temperature in the fan's area or zone may be displayed. This may be preferable in situations where the gaming machine is not part of a sophisticated gaming network or does not have a central monitoring system. In those cases, a floor technician will want to see what the problem is while he or she is at the gaming machine and has opened the cabinet. If there is a central monitoring system, details on the alarm condition may be displayed at a network administrator workstation.

FIG. 4 is a flow diagram of a process of regulating temperature in a gaming machine in accordance with one embodiment. At step 402 the TMSS obtains temperature readings from self-thermal monitoring devices 210 and from one or more temperature monitoring devices (TMDs) 218. The frequency at which the TMSS obtains temperature readings may vary depending on the monitoring devices, the TMDs, and settings in the thermal sub-system. A typical reading from a TMD may come in every 3-4 seconds. The TMD may transmit temperature readings in analog, in which case the TMSS will likely have to convert to digital signals using an A/D converter in one embodiment. Readings from the various self-thermal monitoring devices and from the TMDs may come in at different ports at the thermal sub-system, which may have a series of temperature data input ports or other suitable intake means for receiving such data. An A/D converter may be a component in such an intake means. It is likely that because there may be various self-monitoring devices, TMSS 132 may be able to handle receiving temperature data in different formats.

Another function that may be performed at step 402 is verification that certain control signals were effective. These control signals may have been transmitted earlier, as described below at step 414, essentially making the process of FIG. 4 a feedback loop. Essentially, control signals may have been transmitted to fans or baffles to correct an error condition and at step 402, it is determined whether there is a feedback error; that is, was a control signal that was sent to mitigate a high-temperature condition effective. For example, a baffle should be open because a control signal had been sent to open it, but at step 402 it is detected that the baffle is still closed. In another example, a control signal may have been sent to increase fan speed but the speed of the fan is the same, perhaps the result of a fan malfunction. Essentially, a control signal was sent but failed to adjust a fan, baffle, or other component. It should be noted that this adjustment is to regulate temperature, not necessarily to always lower temperature, rather to keep the temperature (of a component or zone/area) within a certain range. An alarm bit may be set and at step 402, the TMSS will note whether the alarm bit is set or not. In one embodiment, a decision is not made based on the alarm bit but simply whether it is set or not.

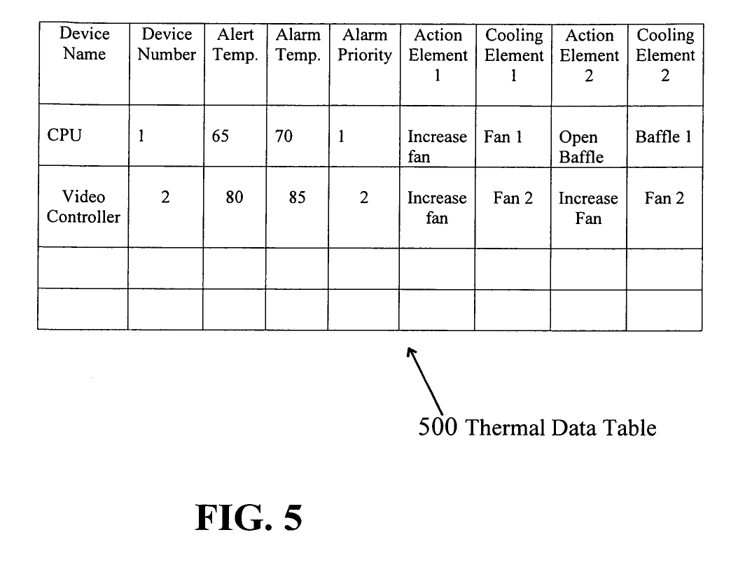

At step 404 the temperatures obtained at step 402 are compared with threshold temperatures in thermal data tables for the various devices and components. In one embodiment, these tables are downloaded to the TMSS prior to normal operation of gaming machine or are installed in the TMSS or in a memory accessible by TMSS during the manufacturing of the gaming machine. The thermal data tables store temperature thresholds, for example, 45.7 degrees as a low and 101.3 degrees as a high. There may be degree ranges within the tables that correspond to below low, low, normal, high, alarm condition, and so on. An example of one implementation of a thermal data table is described in FIG. 5 below. In addition, at step 404 a histogram may also be dynamically created. The threshold temperatures for each range from the thermal tables may be used to calculate ranges for the histograms. Histograms may be useful to prevent the TMSS from being overly reactive to temperature changes, causing continuous feedback. It is generally desirable to keep the system from being too transitive. That is, temperature changes in components/devices or zones should remain within a range for a certain amount of time before control signals are sent to fans, baffles, and other temperature-changing components to adjust the temperature to prevent the continuous feedback. The histograms may be manually derived and downloaded to the TMSS. The goal behind using histograms in this manner and having upper and lower thresholds is to prevent control signals being sent to components to adjust speeds and positions too frequently, resulting, for example, in fans speeding up and slowing down, contributing to the white noise in the casino.

At step 406 the thermal sub-system determines whether there is an out-of-range temperature condition. In one embodiment, both the upper and lower threshold temperatures are checked. If there is a temperature reading that exceeds one of the lower or upper threshold temperatures, control goes to step 408 where another determination is made by the TMSS: Can the out-of-range condition be addressed by an appropriate control signal, such as a fan or baffle control signal? At step 406, if there is no out-of-range condition, control returns to step 402 where the thermal regulation process continues and further temperature readings are obtained.

At step 408 an alarm is set. In this scenario, the out-of-range condition is addressable by a control signal and is an indication that there is a serious temperature condition; one or more of the components or devices has reached a temperature that is too high for the machine and may cause an imminent shut down. Typically, the TMSS will go through the process described so far several times before an alarm is set. At step 410 the alarm is reported via a gaming network over a discrete communication line or to an indicator in the gaming machine that can be seen or hear by a gaming technician. In one embodiment, the TMSS may continue to try to control the temperature after an alarm has been set. Control goes to step 412. If at step 408 it is determined that the out of range condition can be addressed by a control signal (e.g., increasing fan speed or switching a baffle), at step 412 the appropriate control signal or signals are determined and an alarm is not set. In another embodiment, the TMSS may also transmit signals to the power management system to cause the powering off or transitioning into an idle or wait state of a peripheral device. At step 414 the control signal is transmitted to the appropriate mechanism (fan, baffle, or power management system) and control returns to step 402. As noted, when at step 410, when an alarm is set, the system will still try to bring the temperature of the machine into an acceptable range (i.e., cool the machine), and thus control goes to step 412. Once a control signal has been transmitted, control returns to step 402 where, as described above, it is determined whether the control signal worked. In this manner, an error feedback is performed in the process.

FIG. 5 is an example format of a thermal data table in accordance with one embodiment. A table 500 is a data set having a number of rows and columns. Each row corresponds to a heat-emanating component, such as CPU or video processor, as shown in FIG. 5. Examples of other such components are provided above. The columns describe various aspects of a component. In the example shown in FIG. 5, the first column provides a common device name, followed by a device number. Other information may include device manufacturer, model number, serial number, and other data specifically identifying the device. Also provided are columns for “Alert Temperature” and “Alarm Temperature” which contain temperature values for certain thresholds. If the temperature reading of the CPU exceeds 65 degrees, an alert is sent to the casino operator or is set in the gaming machine. If the temperature exceeds 70 degrees F., an alarm is set requiring immediate attention. In other embodiments, various other thresholds may be set, as described above, including lower temperature settings or higher temperature settings (e.g., a high temperature at which the machine should shut down). Columns labeled “Action Element 1” and “Action Element 2” are also shown. These provide short descriptions of actions to be taken to cool the component, such as increase fan speed, switch baffle position, open or close damper, and the like. Each “Action Element” corresponds to “Cooling Element” column (Element 1 and Element 2). These columns describe the temperature controlling element or mechanism that should be used with respect to the instructions provided in the “Action Element” columns. In the examples provided, “Action Element 1” states that Fan 1 should be increased in order to cool the CPU. In one embodiment, Action Element 1 and Cooling Element 1 are used to address an Alert condition and Element 2 is used to address an Alarm condition. Of course, in other embodiments, the data presented in thermal data table 500 may be configured in other ways, such as in a flat file, and may not be arranged in the form of rows and columns. Also shown is an “Alarm Priority” which indicates to the thermal management system which alarm condition should be given priority if there are simultaneous alarms.

Although illustrative embodiments and applications of this invention are shown and described herein, many variations and modifications are possible which remain within the concept, scope, and spirit of the invention, and these variations would become clear to those of ordinary skill in the art after perusal of this application. For example, although airflow is used as the conduction method to cool the machine, other methods may be used, such as liquids (valves) or alternative heat pipe arrangements. While the various embodiments have involved player-related peripheral devices, other types of components and devices that are not player oriented but use high amounts of current and are enabled and disabled on top of standard operation of the gaming machine may also be regulated using the methods described herein. Accordingly, the embodiments described are to be considered as illustrative and not restrictive, and the invention is not to be limited to the details given herein, but may be modified within the scope and equivalents of the appended claims.

What is claimed is:

1. A gaming machine having one or more heat-emanating components, the gaming machine comprising:
a master gaming controller;
one or more baffles;
one or more fans;
a thermal management component for regulating temperatures in the gaming machine;
a temperature measuring device having a temperature-detection span;
a memory storing a thermal specification profile corresponding to the one or more heat-emanating components, wherein the thermal specification profile contains temperature range data.

2. A gaming machine as recited in claim 1 further comprising a fan sensor.

3. A gaming machine as recited in claim 2 wherein the fan sensor is connected to the one or more fans.

4. A gaming machine as recited in claim 1 further comprising a duct positioning sensor.

5. A gaming machine as recited in claim 1 further comprising an airflow sensor.

6. A gaming machine as recited in claim 1 wherein the memory further stores histograms of past temperature readings.

7. A gaming machine as recited in claim 1 wherein the one or more heat-emanating components include self-measuring components and non-self-measuring components.

8. A gaming machine as recited in claim 7 wherein the non-self-measuring are configured within the temperature-detection span of the temperature measuring device.

9. A gaming machine as recited in claim 1 wherein the thermal specification profile includes one or more temperature ranges for the one or more heat-emanating components, a temperature range having a low temperature and one or more high temperatures.

10. A gaming machine as recited in claim 9 wherein the one or more temperatures includes a first high temperature and a second high temperature, the first high temperature being lower than the second high temperature.

11. A gaming machine as recited in claim 1 wherein the thermal specification profile includes a primary action to be taken when temperatures rise in the gaming machine and a first cooling element to be used to lower the temperatures.

12. A gamine machine as recited in claim 1 wherein the thermal specification profile includes a secondary action to be taken when temperatures in the gaming machine and a second cooling element to be used to lower the temperatures.

13. A gaming machine as recited in claim 1 further comprising a power management sub-system.

14. A gaming machine as recited in claim 13 wherein the thermal management component is connected to the power management sub-system.

15. A gaming machine as recited in claim 13 wherein one or more peripheral devices are connected to the power management sub-system and are controlled by the thermal management component.

16. A gaming machine as recited in claim 1 further comprising one or more alarm indicators, an alarm indicator being coupled to the thermal management component.

17. A gaming machine as recited in claim 1 wherein the thermal management component is connected to the master gaming controller.

18. A gaming machine as recited in claim 1 further comprising one or more temperature zones wherein the one or more fans operate to regulate temperature in the one or more zones.

19. A gaming machine as recited in claim 1 wherein the one or more fans include input fans and outlet fans.

20. A gaming machine as recited in claim 18 wherein the one or more baffles operate to regulate temperature in the one or more zones.

21. A method of regulating temperature in a gaming machine, the method comprising:
obtaining a temperature reading of a component;
comparing the temperature reading with one or more threshold temperatures;
determining whether there is an out-of-range temperature condition based on the comparison;
if there is an out-of-range condition, determining if the out-of-range condition can be addressed using a temperature-related control signal; and
if the condition can be addressed using a temperature-related control signal, transmitting the control signal to a fan or a baffle to regulate the temperature.

22. A method as recited in claim 21 further comprising changing airflow in the gaming machine.

23. A method as recited in claim 21 further comprising adjusting the one or more baffles to increase or decrease airflow across the component.

24. A method as recited in claim 21 wherein obtaining temperature reading further comprises:
utilizing a temperature-measuring device having a temperature-detection span.

25. A method as recited in claim 21 wherein the threshold temperatures include a first high temperature and a second high temperature.

26. A method as recited in claim 21 wherein transmitting the control signal to a fan or baffle further comprises:
examining a thermal specification profile storing instructions relating to regulating the temperature.

27. A method as recited in claim 21 further comprises utilizing a thermal management component for controlling temperatures in the gaming machine.

28. A gaming machine comprising:
means for obtaining a temperature reading of a component;
comparison means for comparing the temperature reading with one or more threshold temperatures;
a temperature condition module for determining whether there is an out-of-range temperature condition based on the comparison;
means for determining if the out-of-range condition can be addressed using a temperature-related control signal; and
means for transmitting the control signal to a fan or a baffle to regulate the temperature.

29. A gaming machine as recited in claim 28 wherein the means for obtaining a temperature reading of a component has a temperature-detection span.

30. A gaming machine as recited in claim 28 further comprises a storage means for storing a thermal specification profile containing the threshold temperatures including a first high temperature and a second high temperature.

31. A gaming machine as recited in claim 30 wherein the thermal specification profile further comprises instructions relating to regulating the temperature.

32. A gaming machine as recited in claim 30 wherein the thermal specification profile further comprises cooling element data.

33. A gaming machine as recited in claim 30 wherein the thermal specification profile further comprises alarm priority data.

34. A gaming machine as recited in claim 28 further comprising one or more temperature zones wherein the fan and the baffle operate to regulate temperature in the one or more zones.

35. A gaming machine as recited in claim 28 further comprising a fan tachometer, an airflow sensor, and a duct position sensor.

36. A gaming machine as recited in claim 28 further comprising one or more alarm indicators for indicating that an out-of-temperature range condition has occurred.
